(19) United States
(12) Patent Application Publication
(10) Pub. No.: US 2011/0007998 A1
(43) Pub. Date: Jan. 13, 2011

(54) OPTICAL WAVEGUIDE, OPTO-ELECTRONIC CIRCUIT BOARD, AND METHOD OF FABRICATING OPTO-ELECTRONIC CIRCUIT BOARD

(75) Inventors: Takanori YAMAMOTO, Nagano-shi (JP); Kenji Yanagisawa, Nagano-shi (JP); Hideki Yonekura, Nagano-shi (JP)

Correspondence Address: IPUSA, P.L.L.C, 1054 31ST STREET, N.W., Suite 400, Washington, DC, 20007, US

(73) Assignee: SHINKO ELECTRIC INDUSTRIES CO., LTD.

(21) Appl. No.: 12/829,547

(22) Filed: Jul. 2, 2010

(30) Foreign Application Priority Data
Jul. 7, 2009 (JP) 2009-160896

(51) Int. Cl. G02B 6/13; G02B 6/036; G02B 6/122; B32B 37/02

(52) U.S. Cl. 385/14; 385/126; 156/182

(57) ABSTRACT

An optical waveguide includes first cores provided on a first clad layer, second cores provided on a second clad layer, and a common clad layer interposed between the first and second clad layers and opposing the first and second cores, and the first cores are separated from the second cores.

### CROSS-REFERENCE TO RELATED APPLICATIONS

This application is based upon and claims the benefit of priority of the prior Japanese Patent Application No. 2009-160896, filed on Jul. 7, 2009, the entire contents of which are incorporated herein by reference.

### BACKGROUND OF THE INVENTION

1. Field of the Invention

The present invention relates to optical waveguides, opto-electronic circuit boards, and methods of fabricating opto-electronic circuit boards.

2. Description of the Related Art

In the field of Information Technology (IT), typified by the Internet and optical communication systems, there are demands to increase the communication speed and to increase the operation speed of the systems. Further, with respect to electronic equipments, such as information processing equipments and terminal equipments, that are used in such systems, there are demands to improve performances thereof and to reduce sizes thereof. An opto-electronic circuit board is an example of a popularly used device that forms such equipments. The opto-electronic circuit board processes both optical signals and electrical signals on a single board.

FIG. 1 is a cross sectional view illustrating one example of a conventional opto-electronic circuit board. An opto-electronic circuit board 100 in FIG. 1 includes a stacked structure in which optical wiring layers 14 and electrical wiring layers 15 are stacked. Optical elements (or devices) 11a, 11b, 12a and 12b and electronic elements (or devices) 13 are mounted on the stacked structure. The opto-electronic circuit board 100 includes paths 16a and 16b for optical signals, and the optical wiring layers 14 are stacked via insulator layers 17 at different layer levels of the stacked structure. An opto-electronic circuit board similar to the opto-electronic circuit board 100 is proposed in a Japanese Laid-Open Patent Publication No. 2006-120955, for example.

FIG. 2 is a cross sectional view illustrating another example of the conventional opto-electronic circuit board. An opto-electronic circuit board 101 in FIG. 2 includes an intermediate layer 18 having a predetermined thickness for the purposes of improving the bonding between an optical wiring layer 14 and an electrical wiring layer 15 and improving the mechanical strength of the opto-electronic circuit board 101. An opto-electronic circuit board similar to the opto-electronic circuit board 100 is proposed in a Japanese Laid-Open Patent Publication No. 2005-37531, for example.

According to the conventional opto-electronic circuit boards, the optical wiring layers are located at different layer levels of the stacked structure or, the intermediate layer is interposed between the optical wiring layer and the electrical wiring layer. For this reason, the opto-electronic circuit board as a whole becomes relatively thick, and it is difficult to sufficiently satisfy the demands to improve the performance and to reduce size of the equipment that uses the opto-electronic circuit board. In addition, the fabrication process of the opto-electronic circuit board becomes complex because of the process to provide the optical wiring layers are at the different layer levels of the stacked structure or, the process to interpose the intermediate layer between the optical wiring layer and the electrical wiring layer. As a result, it may be difficult to improve the productivity of the opto-electronic circuit board.

### SUMMARY OF THE INVENTION

Accordingly, it is a general object of the present invention to provide a novel and useful optical waveguide, opto-electronic circuit board, and method of fabricating the opto-electronic circuit board, in which the problems described above are suppressed.

Another and more specific object of the present invention is to provide an optical waveguide, an opto-electronic circuit board, and a method of fabricating the opto-electronic circuit board, which may reduce the size of the optical waveguide and the opto-electronic circuit board, improve the performance and the productivity of the opto-electronic circuit board.

According to one aspect of the present invention, there is provided an optical waveguide comprising a first clad layer; a plurality of first cores provided on the first clad layer; a second clad layer; a plurality of second cores provided on the second clad layer; and a common clad layer interposed between the first clad layer and the second clad layer and opposing the first cores and the second cores, wherein the first cores are separated from the second cores.

According to one aspect of the present invention, there is provided an opto-electronic circuit board comprising an optical waveguide, comprising a first clad layer; a plurality of first cores provided on the first clad layer; a second clad layer; a plurality of second cores provided on the second clad layer; and a common clad layer interposed between the first clad layer and the second clad layer and opposing the first cores and the second cores, wherein the first cores are separated from the second cores; and an electrical circuit board, provided on the first clad layer, and having an electrical circuit layer that includes a plurality of alternately stacked wiring layers and insulator layers.

According to one aspect of the present invention, there is provided a method of fabricating an opto-electronic circuit board, comprising forming a first optical waveguide part by forming a first core on a first clad layer; forming a second optical waveguide part by forming a second core on a second clad layer; bonding the first and second optical waveguide parts via a common clad layer to form an optical waveguide; and bonding an electrical circuit board on the first clad layer of the first optical waveguide part.

Other objects and further features of the present invention will be apparent from the following detailed description when read in conjunction with the accompanying drawings.

### BRIEF DESCRIPTION OF THE DRAWINGS

FIG. 1 is a cross sectional view illustrating one example of a conventional opto-electronic circuit board;

FIG. 2 is a cross sectional view illustrating another example of the conventional opto-electronic circuit board;

FIGS. 3A through 3C are cross sectional views illustrating examples of an optical waveguide in a first embodiment of the present invention and a modification of the first embodiment;

FIG. 4 is a cross sectional view illustrating an example of the opto-electronic circuit board in a second embodiment of the present invention;

FIG. 5 is a cross sectional view illustrating an example of the opto-electronic circuit board in a modification of the second embodiment;

FIGS. 6A and 63 are diagrams for explaining an example of the opto-electronic circuit board in a third embodiment of the present invention;

FIG. 7 is a cross sectional view illustrating an example of the opto-electronic circuit board in a fourth embodiment of the present invention;

FIG. 8 is a cross sectional view illustrating an example of the opto-electronic circuit board in a fifth embodiment of the present invention;

FIG. 9 is a flow chart for explaining an example of a method of fabricating the opto-electronic circuit board in a sixth embodiment of the present invention;

FIGS. 10A through 10C are cross sectional views for explaining the fabrication method of FIG. 9;

FIGS. 10A through 11C are cross sectional views for explaining the fabrication method of FIG. 9;

FIGS. 12A and 123 are cross sectional views for explaining the fabrication method of FIG. 9; and

FIG. 13 is a cross sectional view for explaining the fabrication method of FIG. 9.

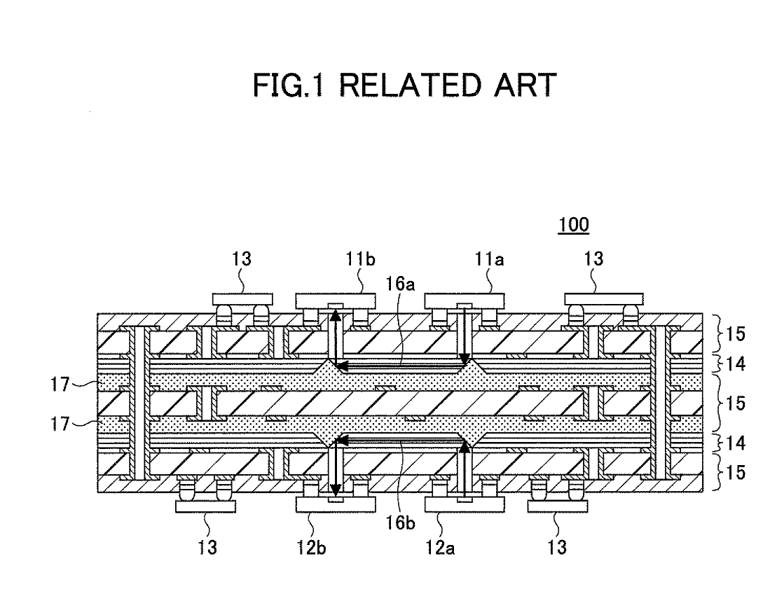

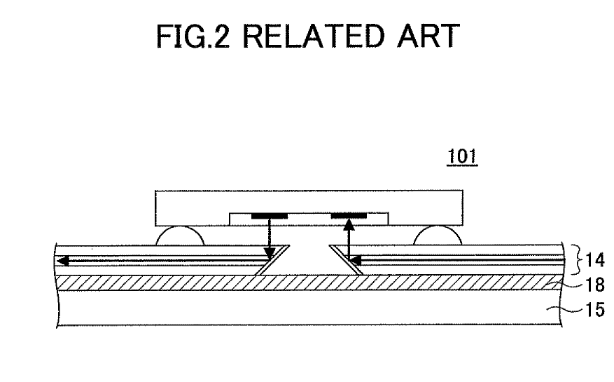

### DESCRIPTION OF THE PREFERRED EMBODIMENTS

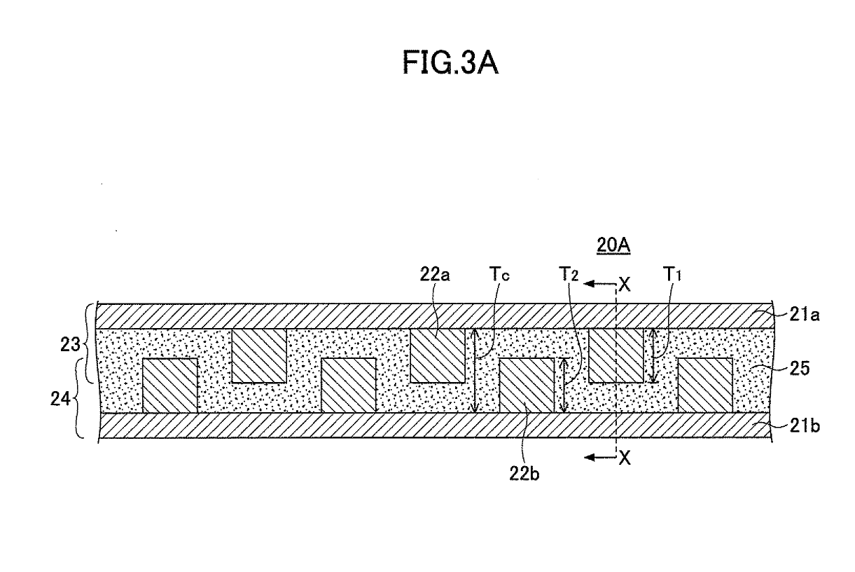

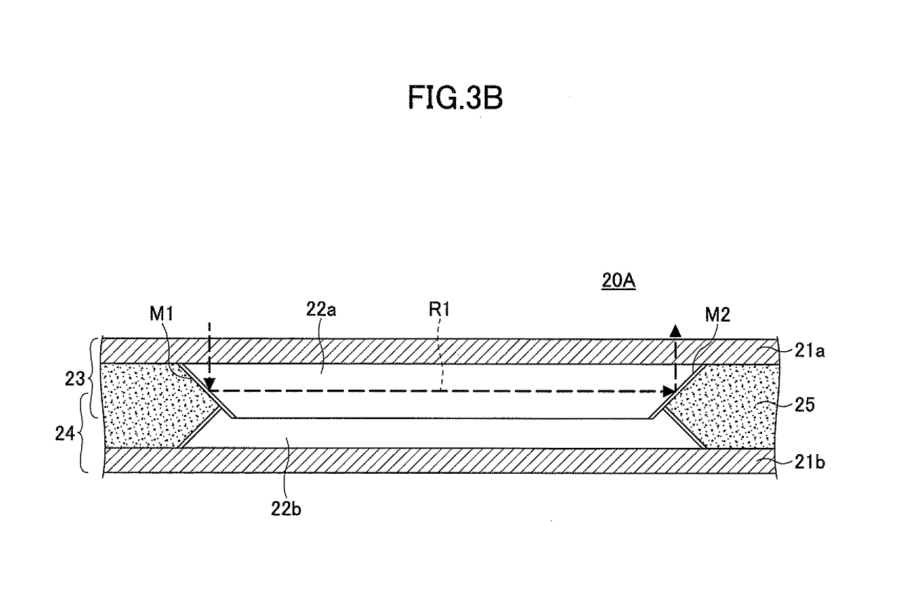

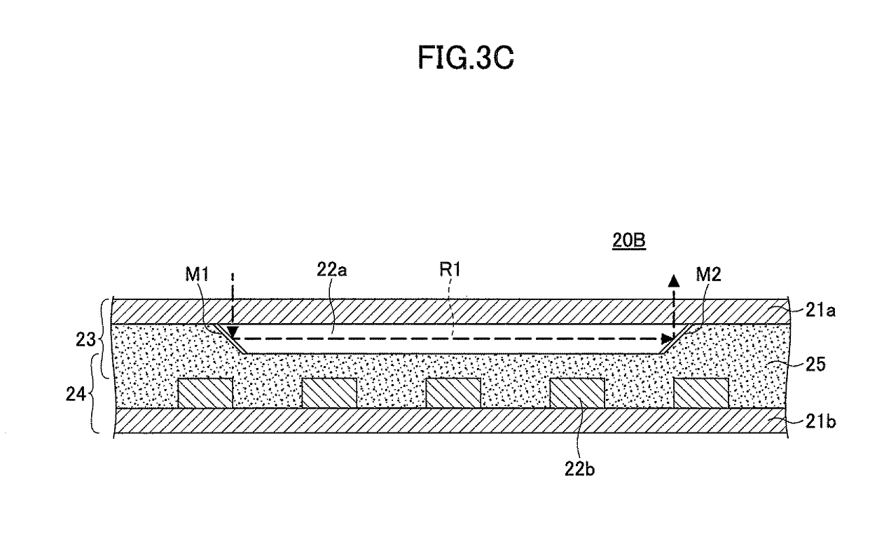

A description will be given of each embodiment of an optical waveguide, an opto-electronic circuit board, and a method of fabricating the opto-electronic circuit board according to the present invention, by referring to FIG. 3A and the subsequent figures.

### First Embodiment

FIGS. 3A through 3C are cross sectional views illustrating examples of an optical waveguide in a first embodiment of the present invention and a modification of the first embodiment. An optical waveguide 20A of the first embodiment illustrated in FIGS. 3A and 3B and an optical waveguide 20B of the modification of the first embodiment illustrated in FIG. 3C both include a first optical waveguide part 23 in which first cores 22a are bonded to a first clad layer 21a, and a second optical waveguide part 24 in which second cores 22b are bonded to a second clad layer 21b. The first optical waveguide 23 and the second optical waveguide 24 are integrally formed via a common clad layer 25 that directly covers the first cores 22a of the first optical waveguide 22 and the second cores 22b of the second optical waveguide 24.

In some of the figures, the cores 22a and 22b are illustrated without hatchings for the sake of convenience, in order to more clearly illustrate the optical path.

FIG. 3A illustrates an example in which the first cores 22a and the second cores 22b are disposed at positions parallel to each other. FIG. 3B illustrates the cross section along a line X-X in FIG. 3A. On the other hand, FIG. 3C illustrates an example in which the first cores 22a and the second cores 22b traverse each other without making contact with each other, such that the first cores 22a and the second cores 22b are arranged in a mutually twisted relationship. In FIG. 3C, an optical axis (that is, a center axis of an optical path) of the first core 22a and an optical axis of the second core 22b intersect each other so that the two optical axes are perpendicular to each other when viewed in a direction in which the first and second clad layers 21a and 21b and the first and second cores 22a and 22b are stacked.

In FIG. 3B, the first core 22a of the first optical waveguide part 23 has an optical path R1 parallel to the paper surface. Mirrors M1 and M2 are provided on respective ends of the first core 22a. The mirrors M1 and M2 function as light propagation direction converting surfaces to change the direction of the optical path R1 of an optical signal that is input to and output from the first optical waveguide part 23. The mirrors M1 and M2 may be disposed on end surfaces of the first core 22a or, disposed at predetermined positions of the first core 22a, with an inclination of 45 degrees with respect to the optical path R1. A metal layer made of gold (Au), silver (Ag), copper (Cu) and the like may be formed on the end surfaces of the first core 22a having the 45-degree inclination, in order to improve the reflectance of the mirrors M1 and M2.

The second core 22b of the second optical waveguide part 24 has an optical path perpendicular to the paper surface in FIG. 3A, and is formed on the surface of the second clad layer 21b. Mirrors (not illustrated) are provided on respective ends of the second core 22b, in a manner similar to the mirrors M1 and M2 provided on the respective ends of the first core 22a.

The common clad layer 25 covers back (or lower) surfaces and side surfaces of the first and second cores 22a and 22b, and bonds to the first and second clad layers 21a and 22b, to thereby form the optical waveguide 20A or the optical waveguide 20B in which the first and second optical waveguide parts 23 and 24 are integrally formed. By minimizing a thickness Tc of the common clad layer 25, it is possible to minimize the thickness of each of the optical waveguides 20A and 20B and to reduce the size of an opto-electronic circuit board that includes the optical waveguide 20A or 20B. For example, if the first and second cores 22a and 22b in FIG. 3B are disposed parallel to each other so as not to overlap each other, the thickness Tc of the common clad layer 25 may be minimized according to the following relationship (1), where T1 denotes a thickness of the first cores 22a, T2 denotes a thickness of the second cores 22b, and max(T1, T2) denotes a maximum value of each of the thicknesses T1 and T2.

max(T1,T2)<Tc (1)

For example, the first and second cores 22a and 22b have a square cross section. In this case, if the thickness T1 of the first cores 22a is 80 μm and the thickness T2 of the second cores 22b is 35 μm, for example, the thickness Tc of the common clad layer 25 may be set to 90 μm which satisfies the above relationship (1). Further, in this case, a thickness of the first clad layer 21a may be 50 μm and a thickness of the second clad layer 21b may be 30 μm, for example. As will be described later, the thickness Tc of the common clad layer 25 may be set depending on the mutual positional relationship of the first and second optical waveguide parts 23 and 24.

For example, each of the first and second cores 22a and 22b may be arranged at a pitch of 250 μm (in a horizontal direction in FIG. 3A, for example).

The first and second cores 22a and 22b may be made of any suitable film-shaped photopolymer that cures when exposed to Ultra-Violet (UV) ray, for example. In addition, the first and second cores 22a and 22b may be made of other suitable liquid polymer materials including polyimide resins, acrylic resins, epoxy resins, polyolefine resins, polynorbornene resins, and fluorides of such resins.

The first and second clad layers 21a and 21b may be made of any suitable film-shaped photopolymer that cures when exposed to UV ray, for example. In addition, the first and second cores 22a and 22b may be made of other suitable liquid polymer materials including polyimide resins, acrylic resins, epoxy resins, polyolefine resins, polynorbornene resins, and fluorides of such resins.

The common clad layer 25 may be made of any suitable material selected from a film-shaped photopolymer that cures when exposed to UV ray, a film-shaped thermosetting resin that cures when exposed to heat, and a liquid photopolymer that cures when exposed to UV ray, for example.

In order to achieve a total reflection of light within each of the first and second cores 22a and 22b at a boundary surface between each of the first and second cores 22a and 22b and the corresponding first and second clad layers 21a and 21b, an index of refraction of the material forming the first and second cores 22a and 22b is set to 1.59 and an index of refraction of the material forming the first and second clad layers 21a and 21b is set to 1.55 for a case where the wavelength of the light is 850 nm, for example. An index of refraction of the common clad layer 25 may be set to the same value as the index of refraction of the first and second clad layers 21a and 21b.

According to the first embodiment and the modification thereof, the first optical waveguide part and the second optical waveguide part are bonded together without interposing a layer, such as a resin substrate, therebetween. As a result, the thickness of the optical waveguide as a whole may be made relatively thin. By appropriately combining this relatively thin optical waveguide and a circuit board, it is possible to fabricate a relatively thin opto-electronic circuit board having a relatively high integration density. It becomes possible to reduce the size of an electronic equipment that uses such an opto-electronic circuit board. The electronic equipment may be selected from various equipments used in optical communication systems, computer systems and the like, including information processing equipments and terminal equipments.

### Second Embodiment

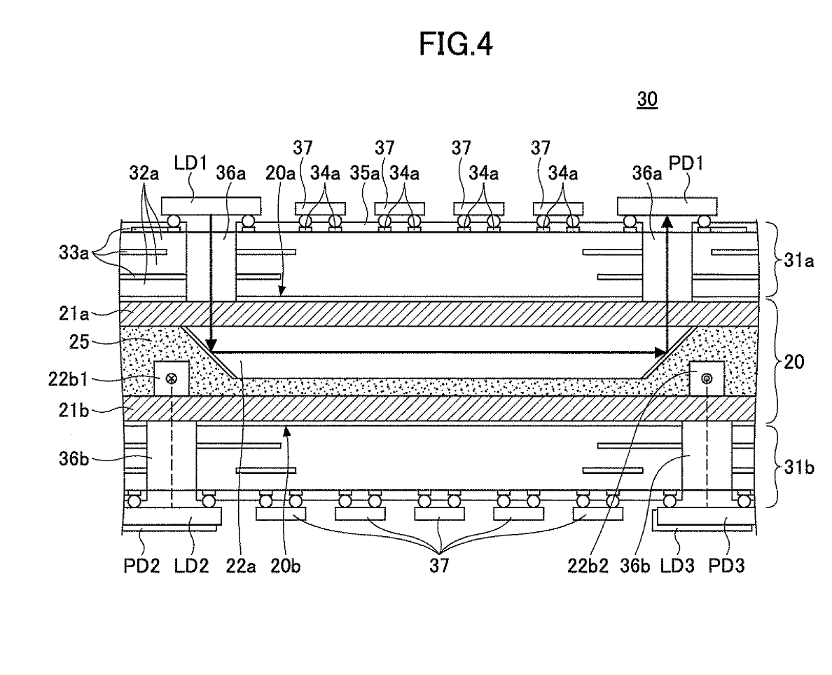

FIG. 4 is a cross sectional view illustrating an example of the opto-electronic circuit board in a second embodiment of the present invention. In FIG. 4, those parts that are the same as those corresponding parts in FIGS. 3A and 3B are either designated by the same reference numerals or the designation by the same reference numerals is omitted, and a description thereof will be omitted.

FIG. 4 illustrates an example in which an opto-electronic circuit board 30 has electrical circuit layers 31a and 31b that are respectively stacked on front and back (or upper and lower) surfaces of an optical waveguide 20. An optical signal emitted from a light emitting element LD1, such as a laser diode, provided on the electrical circuit layer 31a propagates in an optical path that passes through a core 22a and reaches a light receiving element PD1, such as a photodiode, provided on the electrical circuit layer 31a, as illustrated by arrows. In FIG. 4, the opto-electronic circuit board 30 has two other optical paths. With respect to a core 22b1, an optical signal emitted from a light emitting element LD2 propagates in an optical path that passes through an opening 36b, changes propagation direction at a light propagation direction converting mirror (not illustrated), and propagates perpendicularly into the paper surface in FIG. 4 to the back side as indicated by a circular mark within the core 22b1 with a “x”-mark indicated therein, to thereby pass through the core 22b1 and reach a light receiving element PD2. On the other hand, with respect to a core 22b2, an optical signal emitted from a light emitting element LD3 propagates in an optical path that passes through an opening 36b, changes propagation direction at a light propagation direction converting mirror (not illustrated), and propagates perpendicularly out from the paper surface in FIG. 4 to the front side as indicated by a circular mark within the core 22b2, to thereby pass through the core 22b2 and reach a light receiving element PD3.

The electrical circuit layer 31a has a structure of a multi-level (or multi-layer) electrical circuit board in which insulator layers 32a and wiring layers 33a are alternately stacked. External connection terminals 34a and a solder resist layer 35a are formed on a surface of the electrical circuit layer 31a. Electronic elements (or devices) 37 are connected to the external connection terminals 34a. The electrical circuit layer 31a and the electrical circuit layer 31b that is provided on the opposite side from the electrical circuit layer 31a may both be fabricated by bonding a laminated substrate or the like on the surface of the optical waveguide 20 or, stacking an electrical circuit on the surface of the optical waveguide 20.

For example, the opto-electronic circuit board 30 may be 100 mm long and 100 mm wide in a plan view, and a thickness of 2 mm taken along a vertical direction in FIG. 4.

In the example illustrated in FIG. 4, each of the electrical circuit layer 31a and 31b has a stacked structure in which 4 (four) wiring layers are stacked via insulator layers, and has a thickness of 1 mm, for example.

According to the second embodiment, it is possible to provide an opto-electronic circuit board in which an optical waveguide is formed without providing an insulator layer, such as a resin substrate, between a first optical waveguide part and a second optical waveguide part. As a result, it is possible to fabricate a relatively thin opto-electronic circuit board having a relatively high integration density. Consequently, the size of an electronic equipment using the opto-electronic circuit board may be reduced.

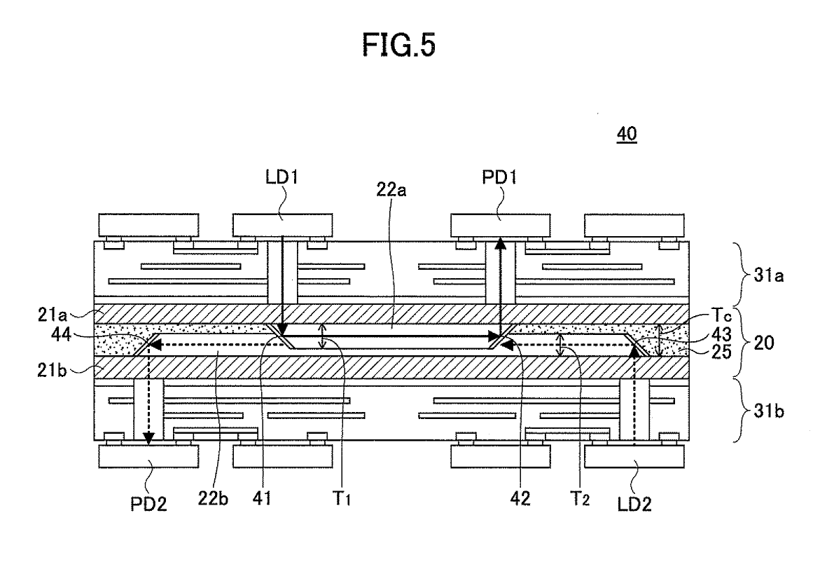

FIG. 5 is a cross sectional view illustrating an example of the opto-electronic circuit board in a modification of the second embodiment. In FIG. 5, those parts that are the same as those corresponding parts in FIGS. 3A and 4 are either designated by the same reference numerals or the designation by the same reference numerals is omitted, and a description thereof will be omitted.

In an opto-electronic circuit board 40 of this modification, a length of the core 22a between 2 (two) light propagation direction converting mirrors located on both end surfaces of the core 22a on the optical axis, is different from a length of the core 22b between 2 (two) light propagation direction converting mirrors located on both end surfaces of the core 22b on the optical axis. In FIG. 5, the length of the core 22a corresponds to a distance between center points 41 and 42 of the 2 light propagation direction converting mirrors located on both end surfaces thereof, and the length of the core 22b corresponds to a distance between center points 43 and 44 of the 2 light propagation direction converting mirrors located on both end surfaces thereof. Hence, it is possible to increase the degree of freedom of design of the opto-electronic circuit board 40 by flexibly coping with optical design conditions of the cores 22a and 22b, even if the lengths of the cores 22a and 22b are different.

In addition, by arranging the cores 22a and 22b parallel to each other as illustrated in FIG. 5, it is possible to minimize the thickness of the optical waveguide 20. In other words, the thickness Tc of the common clad layer 25 may be minimized according to the above relationship (1) in order to reduce the thickness of the optical waveguide 20. Accordingly, the size of an electronic equipment using the opto-electronic circuit board 40 may be reduced.

According to the second embodiment and the modification thereof, it is possible to increase the degree of freedom of design of the opto-electronic circuit board, and the application of the opto-electronic circuit board to electronic equipments may be expanded. In addition, it is possible to fabricate a relatively thin opto-electronic circuit board having a relatively high integration density, and the size of the electronic equipment using the opto-electronic circuit board may be reduced.

### Third Embodiment

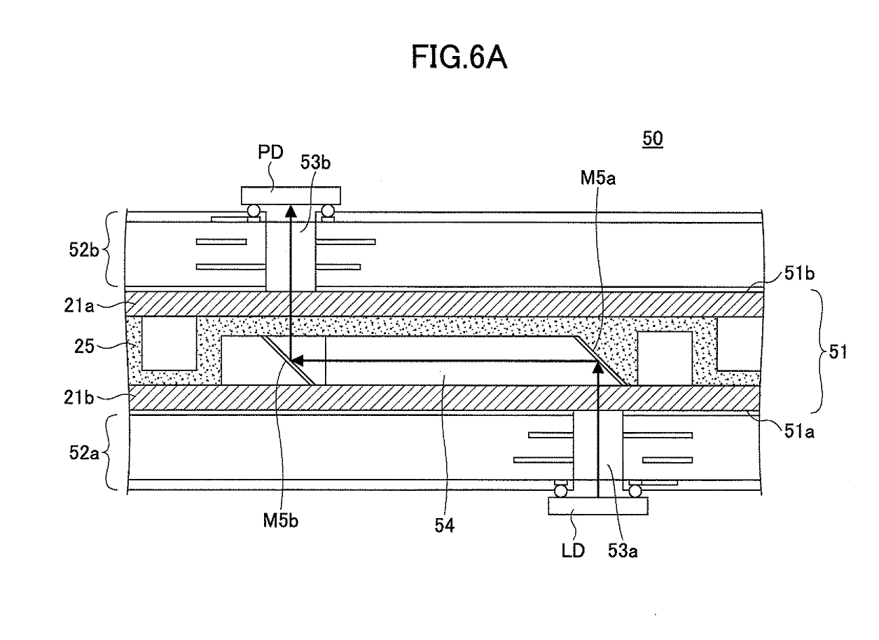

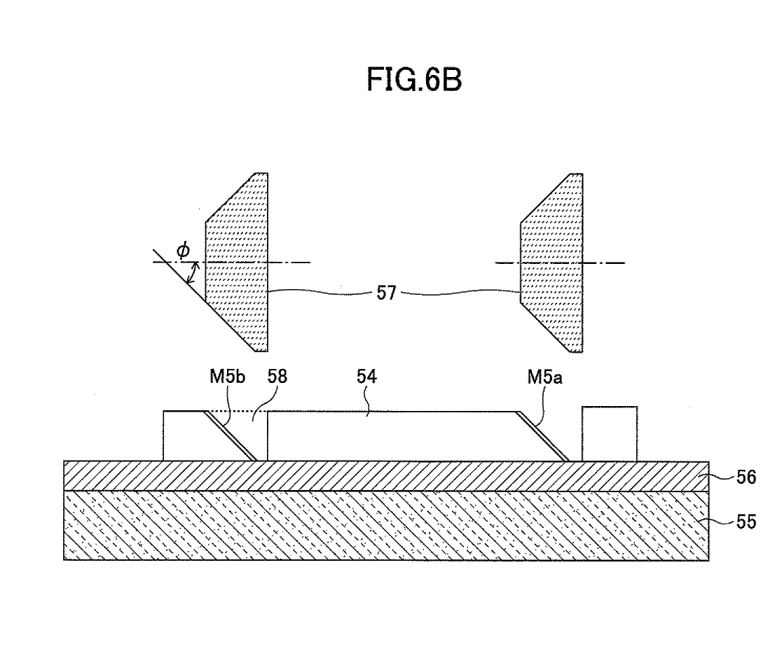

FIGS. 6A and 6B are diagrams for explaining an example of the opto-electronic circuit board in a third embodiment of the present invention. FIG. 6A illustrates a cross section of the example of the opto-electronic circuit board in the third embodiment, and FIG. 6B illustrates a cross section for explaining formation of mirrors. In FIG. 6A, those parts that are the same as those corresponding parts in FIG. 4 are either designated by the same reference numerals or the designation by the same reference numerals is omitted, and a description thereof will be omitted.

In an opto-electronic circuit board 50 illustrated in FIG. 6A, an optical path from one surface 51a of an optical waveguide 51 passes through the optical waveguide 51 in a direction taken along the thickness of the optical waveguide 51, and reaches another surface 51b of the optical waveguide 51. An optical signal emitted from a light emitting element LD on an electrical circuit board 52a enters a core 54 via an opening 53a, is reflected by a light propagation direction converting surface (or mirror) M5a, propagates through the core 54, is reflected by a light propagation direction converting surface (or mirror) M5b, and propagates towards an electrical circuit board 52b and reaches a light receiving element PD via an opening 53b.

As illustrated in FIG. 6B, the light propagation direction converting surfaces M5a and M5b may be formed after providing the core 54 on a clad layer 56 on a support substrate 55, by cutting the core 54 by a blade 57 of a dicer apparatus (not illustrated). One side surface of the blade 57 is perpendicular to a dicer rotary shaft (not illustrated), and the other side surface of the blade 57 is inclined by an angle Ø of 45 degrees with respect to the dicer rotary shaft. A space 58 that is formed by the blade 57 at the light propagation direction converting surface M5b within the core 54 is filled by any one of a material identical to that of the core 54, a resin having an index of refraction identical to that of the material forming the core 54, and the common clad layer 25, in order to prevent scattering of light.

According to the third embodiment, the optical path of the optical signal may be set to extend from one surface of the optical waveguide to the other opposite surface of the optical waveguide by penetrating the optical waveguide. In addition, it is possible to freely select a mutual positional relationship between the light emitting element and the light receiving element on the electrical circuit boards. As a result, it is possible to increase the degree of freedom of design of the opto-electronic circuit board, and to reduce the size and improve the performance of the opto-electronic circuit board.

### Fourth Embodiment

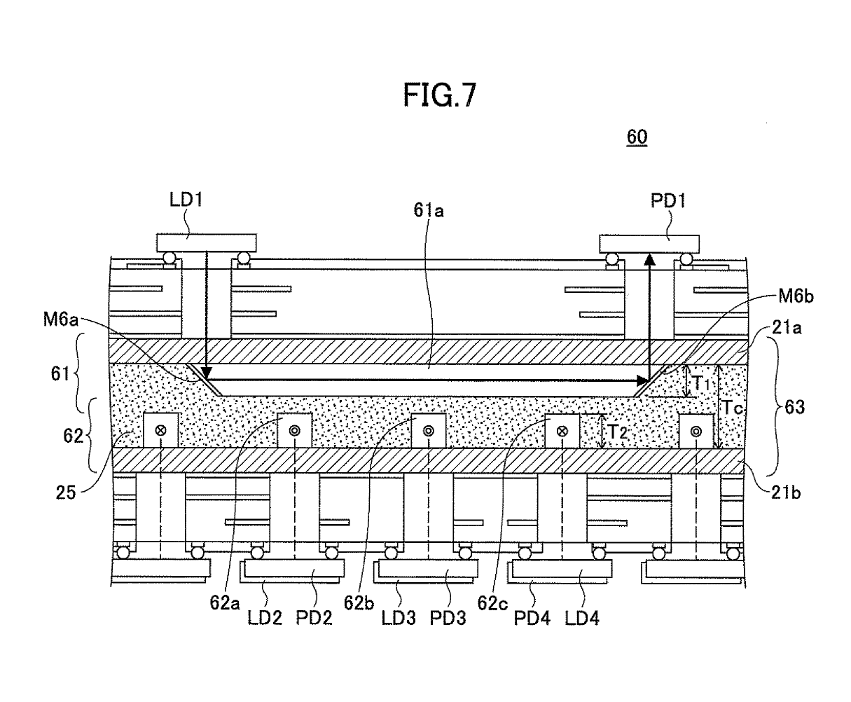

FIG. 7 is a cross sectional view illustrating an example of the opto-electronic circuit board in a fourth embodiment of the present invention. In FIG. 7, those parts that are the same as those corresponding parts in FIGS. 3A through 3C and 4 are either designated by the same reference numerals or the designation by the same reference numerals is omitted, and a description thereof will be omitted.

An opto-electronic circuit board 60 illustrated in FIG. 7 has an optical waveguide 63 in which a core 61a of a first optical waveguide part 61 and cores 62a, 62b and 62c of a second optical waveguide part 62 are arranged in a mutually twisted relationship. The optical waveguide 63 may be formed to have the first core 61a and second cores 62a, 62b and 62c in the mutually twisted relationship by selecting the thickness Tc of the clad layer 25 to satisfy the following relationship (2), where T1 denotes the thickness of the first core 61a, and T2 denotes the thickness of the second cores 62a, 62b and 62c.

T1+T2<Tc (2)

When the first core 61a and the second cores 62a, 62b and 62c are viewed in a plan view of the optical waveguide 63, the first core 61a and the second cores 62a, 62b and 62c extend in mutually perpendicular directions, that is, intersect at 90-degree angles.

With respect to the first core 61a, an optical signal emitted from a light emitting element LD1 is reflected by a light propagation direction converting surface (or mirror) M6a, propagates horizontally from left to right in FIG. 7, and is reflected by a light propagation direction converting surface (or mirror) M6b, to thereby reach a light receiving element PD1.

On the other hand, with respect to the second core 62a, an optical signal emitted from a light emitting element LD2 is reflected by a back light propagation direction converting surface (or mirror, not illustrated), propagates outwardly and perpendicularly to the paper surface in FIG. 7, and is reflected by a front light propagation direction converting surface (or mirror, not illustrated), to thereby reach a light receiving element PD2.

With respect to the second core 62b, an optical signal propagates in a manner similar to the optical signal propagation for the second core 62a.

With respect to the second core 62c, an optical signal emitted from a light emitting element LD4 is reflected by a front light propagation direction converting surface (or mirror, not illustrated), propagates inwardly and perpendicularly to the paper surface in FIG. 7, and is reflected by a front light propagation direction converting surface (or mirror, not illustrated), to thereby reach a light receiving element PD4.

According to the fourth embodiment, it is possible to reduce the size and improve the performance of the optical waveguide in which the first core and the second core are in the mutually twisted relationship described above. Hence, it is possible to improve the integration density and the performance of the opto-electronic circuit board. Further, it is possible to reduce the size and to improve the performance of an electronic equipment that uses the opto-electronic circuit board.

In the fourth embodiment, it is assumed for the sake of convenience that, in the mutually twisted relationship, the first core and the second core respectively extend linearly and are perpendicular to each other when viewed in the plan view of the optical waveguide. However, at least one of the first core and the second core may extend in a non-linear shape (or manner). In addition, the first core and the second core may intersect at an angle other than 90 degrees when viewed in the plan view of the optical waveguide. The effect of reducing the size and improving the performance of the optical waveguide may be obtained even if at least one of the first core and the second core extend in a non-linear shape and/or the first core and the second core intersect at an angle other than 90 degrees when viewed in the plan view of the optical waveguide.

### Fifth Embodiment

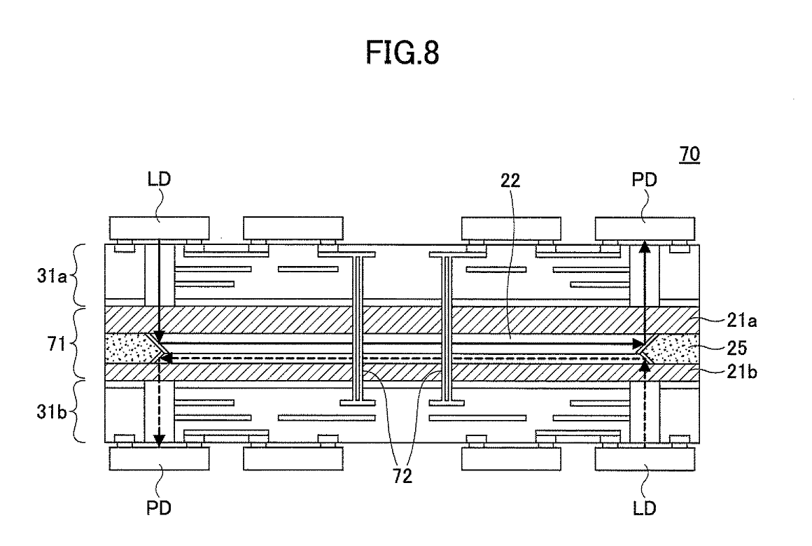

FIG. 8 is a cross sectional view illustrating an example of the opto-electronic circuit board in a fifth embodiment of the present invention. In FIG. 8, those parts that are the same as those corresponding parts in FIG. 4 are either designated by the same reference numerals or the designation by the same reference numerals is omitted, and a description thereof will be omitted.

An opto-electronic circuit board 70 illustrated in FIG. 8 includes an optical waveguide 71, and through hole vias 72 that penetrate the optical waveguide 71. The through hole vias 72 electrically connect wirings and/or circuits of the electrical circuit layers 31a and 31b. For example, the through hole via 72 may be formed by carrying out a laser process or a drilling process with respect to the opto-electronic circuit board 70 having the stacked electrical circuit layers 31a and 31b, to form a via hole from the side of one of the electrical circuit layers 31a and 31b, and carrying out a filling process and/or plating process with respect to the via hole to make the through hole via 72 conductive. The through hole via 72 may be arranged at an arbitrary position that does not cause any of optical, mechanical and thermal effects that would adversely affect the core 22 of the optical waveguide 71.

According to the fifth embodiment, it is possible to provide a relatively compact opto-electronic circuit board having a relatively high performance. In addition, it is possible to increase the degree of freedom of design of the opto-electronic circuit board.

### Sixth Embodiment

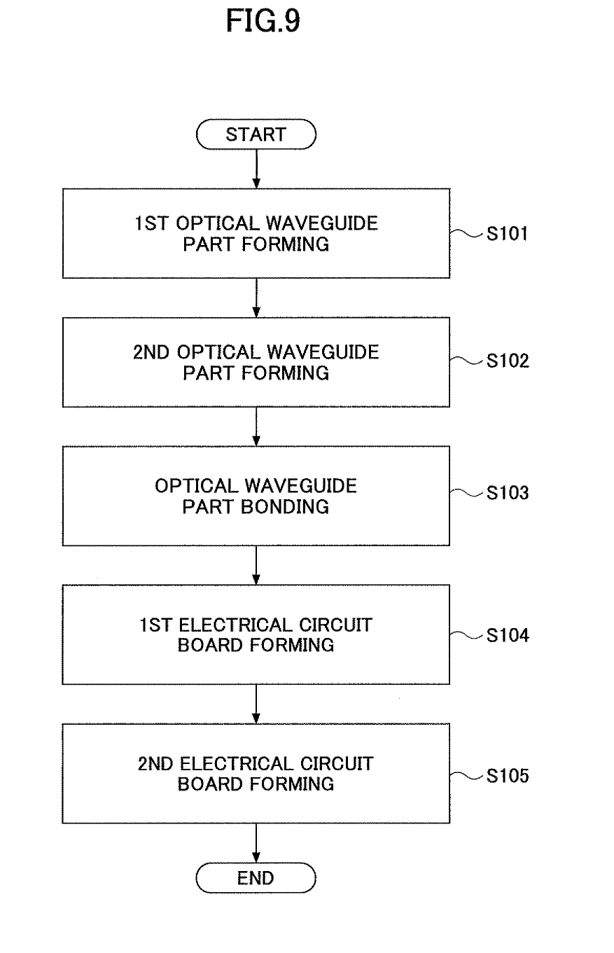

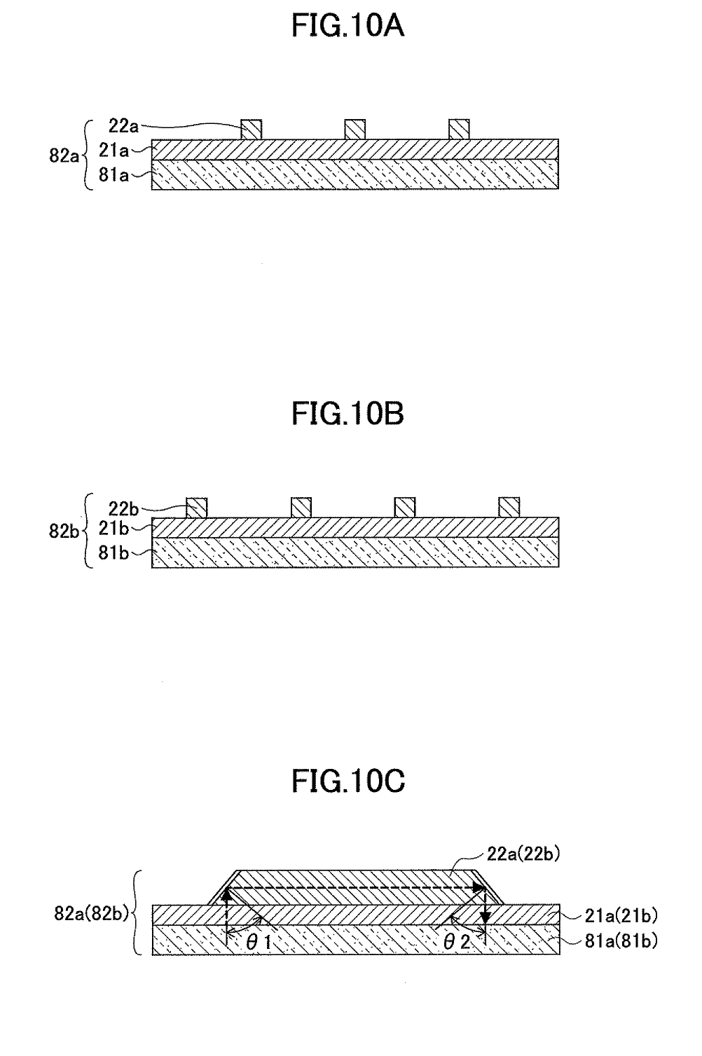

FIG. 9 is a flow chart for explaining an example of a method of fabricating the opto-electronic circuit board in a sixth embodiment of the present invention. In addition, FIGS. 10A through 10C, 11A through 11C, 12A, 12B and 13 are cross sectional views for explaining the fabrication method of FIG. 9.

The fabrication method illustrated in FIG. 9 includes a first optical waveguide part forming step (or process) S101, a second optical waveguide part forming step (or process) 5102, an optical waveguide part bonding step (or process) 5103, a first electrical circuit board forming step (or process) 5104, and a second electrical circuit board forming step (or process) 5105.

FIG. 10A illustrates the first optical waveguide part, FIG. 10B illustrates the second optical waveguide part, and FIG. 10C illustrates a state where light propagation direction converting surfaces (or mirrors) are formed at both ends of the core of the first optical waveguide part. FIGS. 10A and 10B are cross sections viewed in the same direction as FIG. 3A, and FIG. 10C is a cross section viewed in the same direction as FIG. 3B.

[First Optical Waveguide Part Forming Step S101]

First, in the first optical waveguide part forming step S101, a support substrate 81a illustrated in FIG. 10A is prepared. The support substrate 81a has a smooth and planar surface, and may be made of a suitable material selected from a group consisting of silicon, metals, and materials that transmit UV ray, such as polycarbonate resins and acrylic resins. A description of the support substrate 81a made of the material that transmits the UV ray will be given later in conjunction with the optical waveguide part bonding step S103.

Next, a first clad layer 21a is formed on the surface of the support substrate 81a by spin-coating or the like, and cured. In addition, a first core 22a is formed on the surface of the first clad layer 21a, to thereby form a first optical waveguide part 82a. FIG. 10A illustrates a case where three (3) first cores 22a are provided. In order not to deteriorate the transmittance of the optical signal within the first core 22a, the boundary surface between the first core 22a and the first clad layer 21a needs to be smooth and planar. The surface of the support substrate 81a also needs to be smooth and planar because the surface state of the support substrate 81a affects the boundary surface between the first cores 22a and the first clad layer 21a.

The arrangement and dimensions of the first cores 22a may be the same as those described above in conjunction with the first embodiment or, may be appropriately selected depending on the conditions under which the first optical waveguide part 82a is to be used. In addition, the core pattern arrangement and the dimensions of the first optical waveguide part 82a may be different from those of a second optical waveguide part 82b described below.

As described above in conjunction with the first embodiment, the first cores 22a may be formed using a known photolithography technique. In other words, after forming a core layer on the first clad layer 21a, a mask forming process, an exposure process and a developing process are carried out to form each of the first cores 22a. The first clad layer 21a and the first cores 22a may be made of a film-shaped photopolymer, such as an epoxy resin, that cures when exposed to UV ray, as described above in conjunction with the first embodiment. The mask forming process of the photolithography technique may form a mask by depositing a layer made of a resist material that contains silicon, a metal, glass or the like. Alternatively, the mask may be formed by Spin-On-Glass (SOG).

Next, the end surfaces of the first core 22a are cut and polished to form light propagation direction converting surfaces (or mirrors) illustrated in FIG. 10C. The light propagation direction converting surfaces may be formed by cutting the first core 22a by a V-shaped blade, having a tip with a 45-degree angle, of a dicer apparatus (not illustrated) or a micro-machining apparatus (not illustrated). The cutting and polishing process results in the light propagation direction converting surfaces to be inclined relative to the surface of the first clad layer 21a, so that an incoming light signal with respect to the left light propagation direction converting surface in FIG. 10C has an incident angle θ1 with respect to the normal to the left light propagation direction converting surface, and an outgoing light signal with respect to the right light propagation direction converting surface in FIG. 10C has a reflection angle θ2 with respect to the normal to the right light propagation direction converting surface. The angles θ1 and θ2 are desirably 45 degrees, in order to facilitate the alignment and improve the positioning accuracy when mounting the optical elements and the like on the electrical circuit board, so that the productivity of the opto-electrical circuit board is improved. Of course, the angles θ1 and θ2 may be set to angles other than 45 degrees, depending on the design conditions and the like of the electronic equipment in which the opto-electronic circuit board is used.

A metal layer made of gold (Au), silver (Ag), copper (Cu) and the like may be formed on the light propagation direction converting surface, in order to improve the reflectance thereof.

[Second Optical Waveguide Part Forming Step S102]

In the second optical waveguide part forming step S102, the second optical waveguide part 82b illustrated in FIG. 10B is formed in a manner similar to the first optical waveguide part 82a illustrated in FIG. 10A. Compared to the first cores 22a of the first optical waveguide part 82a, each second core 22b is located at an intermediate position between two mutually adjacent first cores 22a, as may be seen from a comparison of FIGS. 10A and 10B. In the example illustrated in FIG. 10B, four (4) second cores 22b are provided.

A support substrate 81b has a smooth and planar surface, and may be made of a suitable material selected from a group consisting of silicon, metals, and materials that transmit UV ray, such as polycarbonate resins and acrylic resins, as in the case of the support substrate 81a. However, the purpose of using a support substrate made of a material that transmits UV ray is to cure the resin material forming the common clad layer 25. For this reason, it is sufficient for at least one of the support substrates 81a and 81b to transmit the UV ray, because the common clad layer 25 may be cured by the UV ray transmitted through at least one of the support substrates 81a and 81b.

The light propagation direction converting surfaces of the second optical waveguide part 82b may be formed by cutting the second core 22a, in a manner similar to that of the first optical waveguide part 82a described above in conjunction with FIG. 10C.

Hence, the second optical waveguide part 82b may basically be formed in a manner similar to the first optical waveguide part 82a described above.

[Optical Waveguide Part Bonding Step S103]

The optical waveguide part bonding step S103 includes a bonding step (or process) 103a, a separating step (or process) 103b, and a surface treatment or finishing step (or process) 103c.

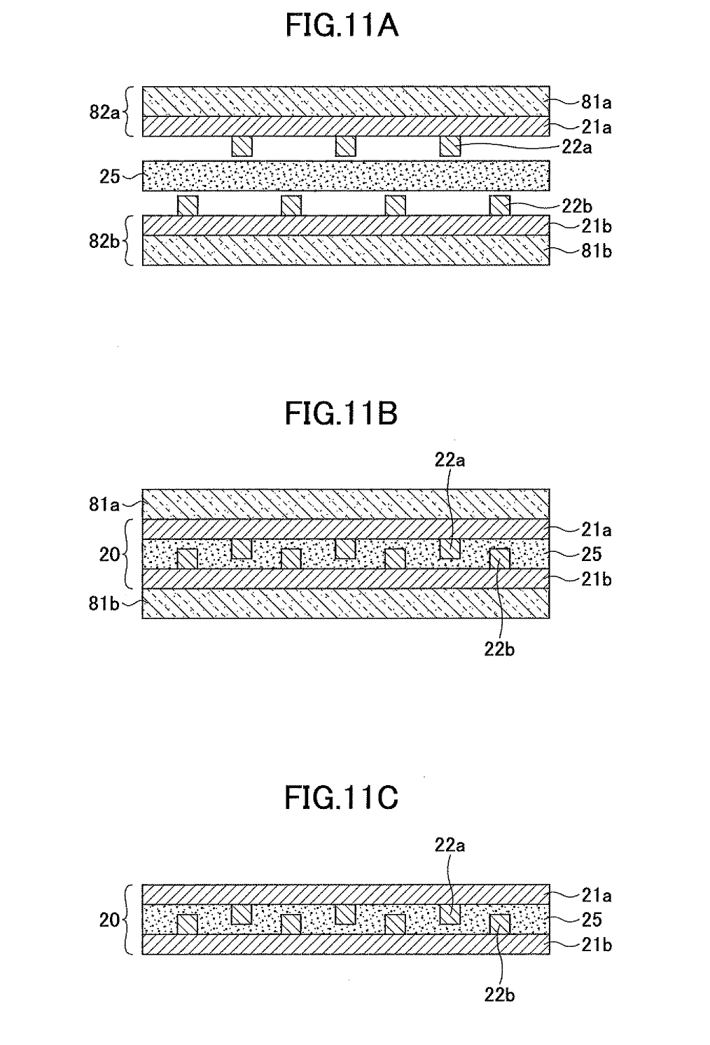

FIG. 11A illustrates a state immediately before the first optical waveguide part 82a having the support substrate 81a illustrated in FIG. 10A and the light propagation direction converting surfaces illustrated in FIG. 10C and turned upside-down is bonded to the second optical waveguide part 82b having the support substrate 81b illustrated in FIG. 10B and the light propagation direction converting surfaces illustrated in FIG. 10C via the common clad layer 25.

[Bonding Step S103a]

FIG. 11B illustrates a state where the first and second optical waveguide parts 82a and 82b are integrally bonded to form an optical waveguide 20 that is supported from both sides by the support substrates 81a and 81b. The bonding step S103a bonds the first and second optical waveguide parts 82a and 82b so that the first core 22a is inserted between two mutually adjacent second cores 22b and the second core 22b is inserted between two mutually adjacent first cores 22a. In other words, the first core 22a occupies the space between two mutually adjacent second cores 22b in the common clad layer 25, and the second core 22b occupies the space between two mutually adjacent first cores 22a in the common clad layer 25. As a result, the thickness of the optical waveguide part 20 in the direction in which the layers are stacked may be made relatively thin.

The common clad layer 25 may be made of any suitable material selected from a film-shaped photopolymer that cures when exposed to UV ray, a film-shaped thermosetting resin that cures when exposed to heat, and a liquid photopolymer that cures when exposed to UV ray, for example. When the photopolymer that cures when exposed to the UV ray is used for the common clad layer 25, at least one of the support substrates 81a and 81b needs to be formed by a material that transmits the UV ray, such as a polycarbonate resin or an acrylic resin.

When the photopolymer that cures when exposed to the UV ray is used for the common clad layer 25, the UV ray is irradiated from at least one of the support substrates 81a and 81b that transmits the UV ray, after the first and second optical waveguide parts 82a and 82b are connected and positioned relative to each other, in order to cure the common clad layer 25. On the other hand, when the thermosetting resin that cures when exposed to heat is used for the common clad layer 25, a heating process is carried out at a temperature of 85° C. and a pressure of 0.6 MPa, for example, after the first and second optical waveguide parts 82a and 82b are connected and positioned relative to each other, in order to cure the common clad layer 25.

If a film-shaped resin is used for the common clad layer 25, it is possible to carry out a lamination using an automatic vacuum laminator apparatus (not illustrated), for example, in order to improve the productivity when fabricating the optical waveguide 20.

[Separating Step S103b]

FIG. 11C illustrates a state after the support substrates 81a and 81b of the first and second optical waveguide parts 82a and 82b are separated and removed from the structure illustrated in FIG. 11B.

The separating step S103b separates and removes the support substrates 81a and 81b of the first and second optical waveguide parts 82a and 82b from the structure illustrated in FIG. 11B, in order to obtain the optical waveguide 20 illustrated in FIG. 11C. The structure illustrated in FIG. 11C is ready to be subjected to a surface treatment or finishing process to facilitate bonding of electrical circuit boards 112a and 112b thereon, as will be described hereunder.

[Surface Treatment or Finishing Step S103c]

The surface treatment or finishing step S103c is carried out with respect to the first and second clad surfaces 21a and 21b of the optical waveguide 20 illustrated in FIG. 11C, in order to improve the bonding strength when bonding the electrical circuit boards 112a and 112b on the first and second clad surfaces 21a and 21b, respectively. For example, a plasma treatment may be carried out to discharge gases absorbed on the surfaces of the first and second clad surfaces 21a and 21b and to etch the polymer layer at the surfaces. Such a plasma treatment cleans and activates the surfaces of the first and second clad surfaces 21a and 21b, to thereby improve the bonding strength when bonding the electrical circuit boards 112a and 112b on the first and second clad surfaces 21a and 21b.

[First Electrical Circuit Board Forming Step S104]

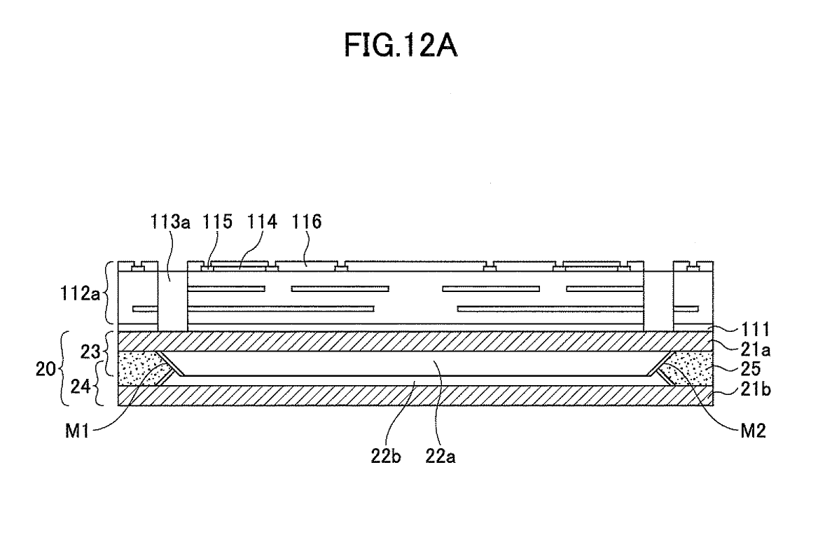

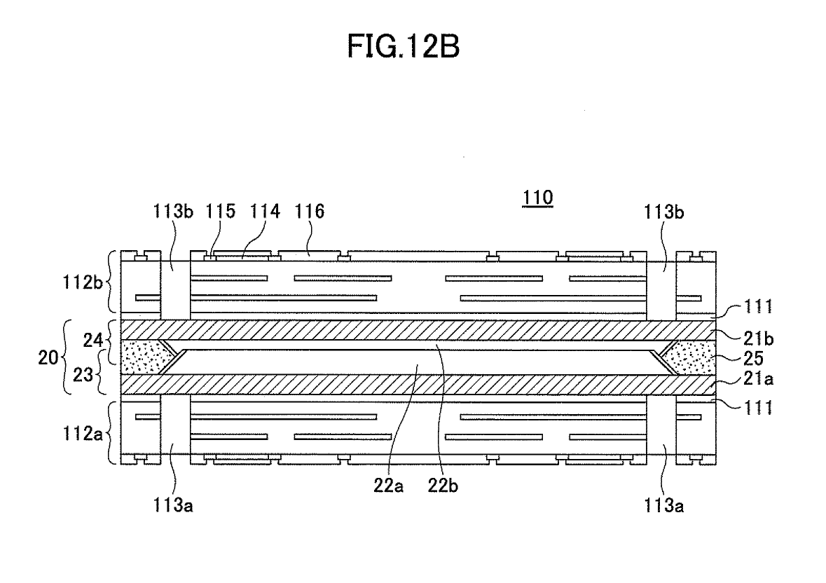

The first electrical circuit board forming step S104 includes a laminating step S104a, an opening forming step S104b, and a stacking step S104c, and forms the first electrical circuit board 112a on the first clad layer 21a of the optical waveguide 20. FIG. 12A illustrates a state where the first electrical circuit board 112a is bonded on the optical waveguide 20.

The laminating step S104a alternately laminates a wiring layer and an insulator layer from a first layer level to an mth layer level, in order to form the first electrical circuit board 112a, where m is a natural number greater than 2.

The opening forming step S104b forms openings 113a for the optical path, in the first electrical circuit board 112a, by a laser process or a drilling process, for example. The opening 113a may have a circular shape in a cross section taken parallel to the surface of the first clad layer 21a (or first electrical circuit board 112a) and viewed in the plan view, and a diameter of this circular shape may be 100 μm, for example. It is possible to prevent optical loss caused by scattering of light, by filling the opening 113a by a resin that transmits light and is identical to that used for the first core 22a.

The stacking step S104c adheres a sheet-shaped bonding layer 111 on the surface of the first clad layer 21a on one side of the optical waveguide 20, aligns the first electrical circuit board 112a relative to the optical waveguide 20, and bonds the first electrical circuit board 112a on the optical waveguide 20 via the sheet-shaped bonding layer 111 by thermo-compression bonding. Thereafter, the sheet-shaped bonding layer 111 is cured by heat, to fix the first electrical circuit board 112a on the optical waveguide 20. Of course, any suitable material, including a liquid material, may be used for the bonding layer 111. In this example, a conductor layer 114, an external connection terminal 115 connected to the conductor layer 114 or the like, and a solder resist layer 116 are provided on a surface of the first electrical circuit board 112a.

Instead of providing the bonding layer 111, it is of course possible to bond the first electrical circuit board 112a on the optical waveguide 20 by other methods. For example, the surface of the first electrical circuit board 112a to be bonded to the optical waveguide 20 may be applied with a clad/bonding material identical to that of the first clad layer 21a and also having a bonding property, so that the first electrical circuit board 112a is bonded to the optical waveguide 20 via the clad/bonding material.

[Second Electrical Circuit Board Forming Step S105]

The second electrical circuit board forming step S105 includes a laminating step S105a, an opening forming step S105b, and a stacking step S105c, and forms the second electrical circuit board 112b on the second clad layer 21b of the optical waveguide 20 that is already provided with the first electrical circuit board 112a. FIG. 12B illustrates a state where the second electrical circuit board 112b is bonded on the optical waveguide 20.

The laminating step S105a alternately laminates a wiring layer and an insulator layer from a first layer level to an nth layer level, in order to form the second electrical circuit board 112b, where n is a natural number greater than 2. Of course, n may be equal to m or not equal to m, and the values of m and n may be arbitrarily selected depending on the conditions under which the opto-electronic circuit board is to be used, for example.

The opening forming step S105b and the stacking step S105c may be carried out in a manner similar to the opening forming step S104b and the stacking step S104c described above, and a description thereof will be omitted.

The electrical circuit board bonded to the optical waveguide is not limited to the electrical circuit board formed by the lamination described above, and for example, a flexible circuit board (or FPC: Flexible Printed Circuit) may be bonded the optical waveguide to form the opto-electronic circuit board. For example, a flexible circuit board may have 3 (three) layer levels amounting to a thickness of 0.3 mm, and such a flexible circuit board may be bonded on both sides of the optical waveguide to form an opto-electronic circuit board having a thickness of 0.9 mm.

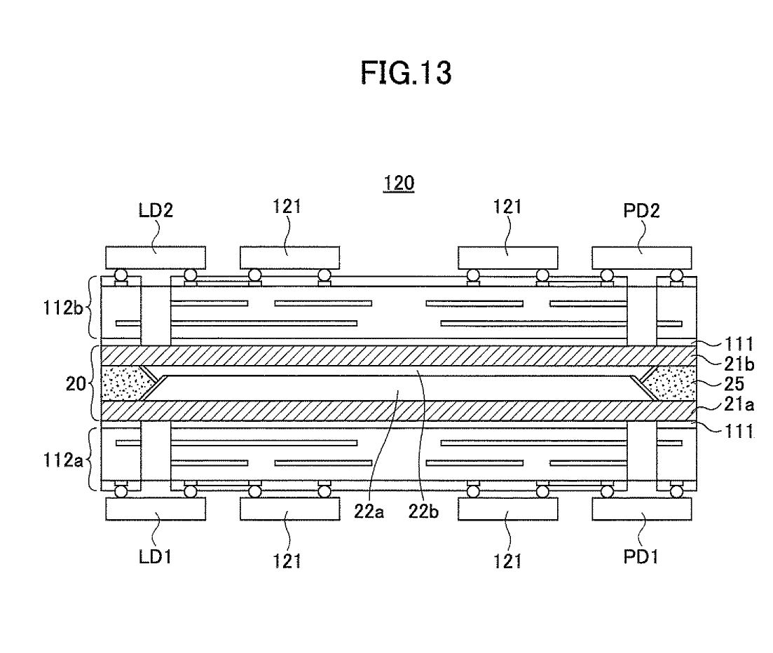

Next, optical elements and electronic elements are mounted on the opto-electronic circuit board illustrated in FIG. 12B, to form an opto-electronic circuit board 120 illustrated in FIG. 13.

FIG. 13 illustrates an example in which optical elements, such as light emitting elements LD1 and LD2 and photodiodes PD1 and PD2, and electronic elements 121, are mounted on respective surfaces of the opto-electronic circuit board 120, that is, on the first and second electrical circuit boards 112a and 112b. The light receiving element PD1 receives the light emitted from the light emitting element LD1 on the first electrical circuit board 112a, the light receiving element LD2 receives the light emitted from the light emitting element LD2 on the second electrical circuit board 112b, and the electronic elements 121 operate in the electrical circuits on the first and second electrical circuit boards 112a and 112b.

According to the sixth embodiment, it is possible to simplify the process of forming the opto-electronic circuit board, and to improve the productivity of the opto-electronic circuit board having the relatively high integration density. In addition, when fabricating the opto-electronic circuit board, the optical waveguide and the electrical circuit boards may be fabricated by separate processes and be bonded thereafter. The fabrication process of the opto-electronic circuit board may be simplified because the optical waveguide and the electrical circuit boards may be fabricated by separate processes. Further, because the optical waveguide may be isolated from the optical, mechanical and thermal effects at the time of fabricating the electrical circuit boards, it is possible to improve the quality and productivity of the opto-electronic circuit board.

Of course, instead of forming the electrical circuit board by the lamination described above, the electrical circuit board may be fabricated by other suitable methods, such as stacking copper or metal plated substrates.

Further, the present invention is not limited to these embodiments, but various variations and modifications may be made without departing from the scope of the present invention.

What is claimed is:

1. An optical waveguide comprising:
a first clad layer;
a plurality of first cores provided on the first clad layer;
a second clad layer;
a plurality of second cores provided on the second clad layer; and
a common clad layer interposed between the first clad layer and the second clad layer and opposing the first cores and the second cores,
wherein the first cores are separated from the second cores.

2. The optical waveguide as claimed in claim 1, wherein a thickness of the common clad layer is greater than a maximum thickness of each of the first and second cores.

3. The optical waveguide as claimed in claim 1, wherein the first cores and the second cores are arranged in a mutually twisted relationship.

4. The optical waveguide as claimed in claim 1, wherein an arbitrary one of the first cores is arranged between two mutually adjacent second cores within the common clad layer.

5. The optical waveguide as claimed in claim 4, wherein the first and second cores extend linearly.

6. The optical waveguide as claimed in claim 5, wherein an optical axis of one first core and an optical axis of one second core 22b intersect each other so that the optical axes are perpendicular to each other when viewed in a direction in which the first and second clad layers and the first and second cores are stacked.

7. An opto-electronic circuit board comprising:
an optical waveguide, comprising:
a first clad layer;
a plurality of first cores provided on the first clad layer;
a second clad layer;
a plurality of second cores provided on the second clad layer; and
a common clad layer interposed between the first clad layer and the second clad layer and opposing the first cores and the second cores,
wherein the first cores are separated from the second cores; and
a first electrical circuit board, provided on the first clad layer, and having an electrical circuit layer that includes a plurality of alternately stacked wiring layers and insulator layers.

8. The opto-electronic circuit board as claimed in claim 7, further comprising:
a second electrical circuit board, provided on the second clad layer, and having an electrical circuit layer that includes a plurality of alternately stacked wiring layers and insulator layers.

9. The opto-electronic circuit board as claimed in claim 8, further comprising:
a through hole via, penetrating the optical waveguide, and electrically connecting the first and second electrical circuit boards.

10. The opto-electronic circuit board as claimed in claim 9, further comprising:
optical elements and electronic elements provided on each of the first and second electrical circuit boards.

11. A method of fabricating an opto-electronic circuit board, comprising:
forming a first optical waveguide part by forming a first core on a first clad layer;
forming a second optical waveguide part by forming a second core on a second clad layer;
bonding the first and second optical waveguide parts via a common clad layer to form an optical waveguide; and
bonding a first electrical circuit board on the first clad layer of the first optical waveguide part.

12. The method of fabricating the opto-electronic circuit board as claimed in claim 11, further comprising:
bonding a second electrical circuit board on the second clad layer of the second optical waveguide part.

13. The method of fabricating the opto-electronic circuit board as claimed in claim 12, further comprising:
forming a through hole via that penetrates the optical waveguide and electrically connects the first and second circuit boards.

14. The method of fabricating the opto-electronic circuit board as claimed in claim 10, wherein said bonding the first electrical circuit board uses a flexible printed circuit as the first electrical circuit board.
